(19) United States
(12) Patent Application Publication
(10) Pub. No.: US 2006/0122049 A1
(43) Pub. Date: Jun. 8, 2006

(54) Method of making glass microbubbles and raw product

(75) Inventors: Harry J. Marshall, Hudson, WI (US); Madeline P. Shinbach, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/004,385

(22) Filed: Dec. 3, 2004

(51) Int. Cl. C03C 6/00; C03C 12/00; C03B 19/10

(52) U.S. Cl. 501/27; 501/33; 65/21.4

(57) ABSTRACT

Raw product comprising glass microbubbles is formed by heating feed having a size distribution with a span of less than 0.9. The raw product may have a size distribution with a span of less than 0.80.

### BACKGROUND

Hollow glass beads having a mean diameter of less than about 500 micrometers, also commonly known as “hollow glass microspheres” or “glass microbubbles”, are widely used in industry, for example, as additives to polymeric compounds where they may serve as modifiers, enhancers, rigidifiers, and/or fillers. Generally, it is desirable that the glass microbubbles be strong to avoid being crushed or broken during further processing of the polymeric compound, such as by high pressure spraying, kneading, extrusion or injection molding.

Glass microbubbles are typically made by heating milled frit, commonly referred to as “feed”, that contains a blowing agent such as, for example, sulfur or a compound of oxygen and sulfur. The resultant product (i.e., “raw product”) obtained from the heating step typically contains a mixture of glass microbubbles (including broken glass microbubbles) and solid glass beads, the solid glass beads generally resulting from milled frit particles that failed to form glass microbubbles for whatever reason.

The milled frit is typically obtained as a relatively broad distribution of particle sizes. During heating, the larger particles tend to form glass microbubbles that are more fragile than the mean, while the smaller particles tend to increase the density of the hollow glass bead distribution. In the case that larger glass microbubbles become broken, the average density of the glass bead distribution containing the broken bead portions also generally increases.

### SUMMARY

In one aspect, the present invention provides a method of forming glass microbubbles comprising heating feed under conditions sufficient to convert at least a portion of the feed into raw product comprising glass microbubbles, wherein the feed has a size distribution with a span of less than 0.9.

In one embodiment, the feed is provided by a method comprising:

milling frit to provide milled frit; and

classifying the milled frit.

In another aspect, the present invention provides a raw product comprising glass microbubbles, wherein on a weight basis a majority of the raw product comprises glass microbubbles, and wherein the plurality of raw product has a size distribution with a span of less than 0.80.

For any given heating process, it is generally the case that the density of the resultant hollow glass bead distribution correlates with the throughput rate at which the feed is converted into glass microbubbles. Thus, in order to produce low density glass microbubbles it is generally necessary to use relatively lower throughput rates using a given process and apparatus. By using feed having a narrower particle size distribution than those currently used by the glass microbubble industry, the present invention generally achieves at least one of the following: (1) a low density distribution of glass microbubbles having an average crush strength comparable to higher density distributions of glass microbubbles; or (2) an increased throughput rate while obtaining glass microbubbles of average density and/or crush strengths typically associated with glass microbubbles produced at lower throughput rates using the same heating apparatus and conditions.

### DETAILED DESCRIPTION

Frit may be prepared, for example, by crushing and/or milling a suitable glassy material, typically a relatively low melting silicate glass containing a suitable amount of blowing agent. Silicate glass compositions suitable for forming frit are described, for example, in U.S. Pat. No. 2,978,340 (Veatch et al.); U.S. Pat. No. 3,030,215 (Veatch et al.); U.S. Pat. No. 3,129,086 (Veatch et al.); and U.S. Pat. No. 3,230,064 (Veatch et al.); U.S. Pat. No. 3,365,315 (Beck et al.); and U.S. Pat. No. 4,391,646 (Howell), the disclosures of which are incorporated herein by reference.

Although the frit and/or the feed may have any composition that is capable of forming a glass, typically, on a total weight basis, the frit comprises from 50 to 90 percent of SiO₂, from 2 to 20 percent of alkali metal oxide, from 1 to 30 percent of B₂O₃, from 0.005-0.5 percent of sulfur (e.g., as elemental sulfur, sulfate or sulfite), from 0 to 25 percent divalent metal oxides (e.g., CaO, MgO, BaO, SrO, ZnO, or PbO), from 0 to 10 percent of tetravalent metal oxides other than SiO₂ (e.g., TiO₂, MnO₂, or ZrO₂), from 0 to 20 percent of trivalent metal oxides (e.g., Al₂O₃, Fe₂O₃, or Sb₂O₃), from 0 to 10 percent of oxides of pentavalent atoms (e.g., P₂O₅ or V₂O₅), and from 0 to 5 percent fluorine (as fluoride) which may act as a fluxing agent to facilitate melting of the glass composition. Additional ingredients are useful in frit compositions and can be included in the frit, for example, to contribute particular properties or characteristics (e.g., hardness or color) to the resultant glass microbubbles.

In the above-mentioned frit compositions, sulfur (presumably combined with oxygen) serves as a blowing agent that, upon heating, causes expansion of molten frit particles to form glass microbubbles. By controlling the amount of sulfur in the feed, the amount and length of heating to which the feed is exposed, the mean particle size, and the rate at which particles are fed through a flame the amount of expansion of the feed particles can typically be controlled to provide glass microbubbles of a selected density. Although the frit generally includes sulfur within a range of about 0.005 to 0.7 weight percent, more typically, the sulfur content of the frit is in a range of from 0.01 to 0.64 percent by weight, or even in a range of from 0.05 to 0.5 percent by weight.

The frit is typically milled, and optionally classified, to produce feed of suitable particle size for forming glass microbubbles of the desired size. Methods that are suitable for milling the flit include, for example, milling using a bead or ball mill, attritor mill, roll mill, disc mill, jet mill, or combination thereof. For example, to prepare feed of suitable particle size for forming glass microbubbles, the frit may be coarsely milled (e.g., crushed) using a disc mill, and subsequently finely milled using a jet mill.

Jet mills are generally of three types: spiral jet mills, fluidized-bed jet mills, and opposed jet mills, although other types may also be used.

Spiral jet mills include, for example, those available under the trade designations “MICRONIZER JET MILL” from Sturtevant, Inc., Hanover, Mass.; “MICRON-MASTER JET PULVERIZER” from The Jet Pulverizer Co., Moorestown, N.J.; and “MICRO-JET” from Fluid Energy Processing and Equipment Co., Plumsteadville, Pa. In a spiral jet mill a flat cylindrical grinding chamber is surrounded by a nozzle ring. The material to be ground is introduced as particles inside the nozzle ring by an injector. The jets of compressed fluid expand through the nozzles and accelerate the particles, causing size reduction by mutual impact.

Fluidized-bed jet mills are available, for example, under the trade designations “CGS FLUIDIZED BED JET MILL” from Netzsch Inc., Exton, Pa.; and “ROTO-JET” from Fluid Energy Processing and Equipment Co. The lower section of this type of machines is the grinding zone. A ring of grinding nozzles within the grinding zone is focused toward a central point, and the grinding fluid accelerates particles of the material being milled. Size reduction takes place within the fluidized bed of material, and this technique can greatly improve energy efficiency.

Opposed jet mills are similar to fluidized-bed jet mills, except at least two opposed nozzles accelerate particles, causing them to collide at a central point. Opposed jet mills may be commercially obtained, for example, from CCE Technologies, Cottage Grove, Minn.

There are many ways to describe the width of a particle size distribution. In one method, the width of a particle size distribution can be expressed by the following formula:

$$\frac{90 P - 10 P}{50 P} = GQ = span$$

wherein 90P is the size for which 90 percent of the particles in the distribution are smaller (referred to as the 90th percentile size); 10P is the size for which only 10 percent of the particles in the distribution are smaller (referred to as the 10th percentile size); 50P is the size for which 50 percent of the particles in the distribution are smaller (referred to as the 50th percentile size); and GQ stands for the gradation quotient. The gradation quotient is also commonly known in the art by the term “span”.

Another common method, particularly useful for Gaussian particle size distributions, uses the mean and standard deviation of the particle sizes to describe the distribution.

According to the present invention, the milled frit is classified to yield a distribution of having a span of less than 0.9, which is then used as feed for forming glass microbubbles. For example, the feed may have a span of less than 0.85, 0.80, or even less than 0.75; the span may also be at least 0.7. In order to form glass microbubbles on heating, the feed typically has a mean particle size of from at least about 3 to about 100 micrometers, more typically from at least about 3 to about 50 micrometers, and more typically from at least about 5 to about 25 micrometers.

By utilizing narrow feed distributions, the present invention provides an additional degree of control that may be used in the production of glass microbubbles as compared to current methods for forming glass microbubbles known in the art. Typically, the main process variables in the formation of glass microbubbles are the equipment, sulfur content, and the feed rate, and median feed size. Controlling the feed size distribution according to the present invention advantageously provides an additional process variable that may be varied to achieve a desired result.

Classification is performed such that at least one fraction, typically the coarsest classified portion, of the feed has a span of less than 0.9. This fraction is therefore isolated and used as the feed for the manufacture of the glass microbubbles. Remaining finer and/or coarser fraction(s) may be, for example, used to make glass microbubbles having physical properties comparable to existing glass microbubbles or reprocessed into frit.

Typically, as obtained from the above-mentioned mills each technique produces feed having a distribution of particle sizes. Typically, feed obtained from milling will not have a span of less than 0.9, and in such cases additional classification according to the present invention is desirable.

Suitable apparatus for classifying the feed include, for example, vibrating screens (including sieves), air classifiers, and wet classifiers. Other methods of classifying the feed may also be used.

Suitable screens include, for example, sieves having a designation of from about 35 mesh through at least about 400 mesh according to ASTM Designation: E11-04 entitled “Standard Specification for Wire Cloth and Sieves for Testing Purposes”. Such sieves may be obtained from commercial suppliers such as, for example, Newark Wire Cloth Company, Newark, N.J.

Suitable air classifiers include, for example, gravitational classifiers, inertial classifiers, and centrifugal classifiers. Air classifiers are readily available from commercial sources, for example, as available from Hosokawa Micron Powder Systems under the trade designations “MICRON SEPARATOR”, “ALPINE MODEL 100 MZR”, “ALPINE TURBOPLEX ATP”, “ALPINE STRATOPLEX ASP”, or “ALPINE VENTOPLEX”; or from Sepor, Inc., Wilmington, Calif. under the trade designation “GAYCO CENTRIFUGAL SEPARATOR”.

Once the feed has the desired span, it is fed into a heat source (e.g., a gas/air flame, approximately stoichiometric) and then cooled. Upon exposure to the heat source the feed typically softens and the blowing agent causes at least a portion of the softened feed to expand and, after cooling, form a raw product that comprises glass microbubbles, optionally in combination with broken microbubble glass fragments and/or solid glass beads that did not expand during heating. Generally, it is possible to adjust process conditions such that at least a majority by weight of the raw product comprises glass microbubbles. More typically, at least 60, 70, 80, or even 90 percent by weight of the raw product comprises glass microbubbles. If desired, at least a portion of the glass microbubbles may be isolated from the raw product, for example, by using flotation techniques as described in U.S. Pat. No. 4,391,646 (Howell).

Glass microbubbles may be prepared on apparatus such as those described, for example, in U.S. Pat. No. 3,230,064 (Veatch et al.) or U.S. Pat. No. 3,129,086 (Veatch et al.). Further details concerning heating conditions may be found for example in U.S. Pat. No. 3,365,315 (Beck et al.) and U.S. Pat. No. 4,767,726 (Marshall), the disclosures of which are incorporated herein by reference.

According to the present invention, the raw product typically has a mean particle size in a range of from 5 to 250 micrometers, more typically 30 to 150 micrometers, more typically 30 to 110 micrometers. In some embodiments, the raw product may have a mean particle size of at least 70 micrometers. The raw product has a span of less than 0.80, or in some embodiments, less than 0.75, 0.70, 0.65, or even less than 0.60.

In one embodiment, the glass microbubbles may have a weight ratio of alkaline earth metal oxide to alkali metal oxide weight ratio in a range of 1.2:1 to 3.0:1, and wherein at least 97 percent by weight of the combined weight of the alkaline earth metal oxide and alkali metal oxide comprises, on a weight basis, of 70 to 80 percent SiO2, 8 to 15 percent CaO, 3 to 8 percent Na₂O, and 2 to 6 percent B₂O₃.

Glass microbubbles prepared according to the present invention may be included in polymeric materials and may optionally be mixed with solid glass beads. Examples of suitable polymeric materials include thermoset, thermoplastic, and elastomeric polymeric materials.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

In the following examples:

“borax” refers to anhydrous borax; Na₂O: 2B₂O₃, 90 percent smaller than 590 micrometers, obtained from US Borax, Boron, Calif.;

“CaCO₃” refers to calcium carbonate, 97 percent smaller than 44 micrometers, obtained from Imerys, Sylacauga, Ala.;

“Li₂CO₃” refers to lithium carbonate; finer than 420 micrometers obtained from Lithium Corp. of America, Gastonia, N.C.;

“SiO₂” refers to silica flour, obtained from US Silica, Berkeley Springs, W. Va.;

“Na₂CO₃” refers to soda ash, obtained from FMC Corp., Greenvine, Wyo.;

“Na₂SO₄” refers to sodium sulfate, 60 percent smaller than 74 micrometers, obtained from Searles Valley Mineral, Trona, Calif.; and

“Na₄P₂O₇” refers to tetrasodium pyrophosphate, 90 percent smaller than 840 micrometers, obtained from Astaris, St. Louis, Mo.

Test Methods

Average Particle Density Determination

A fully automated gas displacement pycnometer obtained under the trade designation “ACCUPYC 1330 PYCNOMETER” from Micromeritics, Norcross, Ga., was used to determine the density of the composite material and glass residual according to ASTM D-2840-69, “Average True Particle Density of Hollow Microspheres”.

Particle Size Determination

Particle size distribution was determined using a particle size analyzer available under the trade designation “COULTER COUNTER LS-130” from Beckman Coulter, Fullerton, Calif.

Strength Test

The strength of the glass microbubbles is measured using ASTM D3102-72; “Hydrostatic Collapse Strength of Hollow Glass Microspheres” with the exception that the sample size of glass microbubbles is 10 mL, the glass microbubbles are dispersed in glycerol (20.6 g) and data reduction was automated using computer software. The value reported is the hydrostatic pressure at which 10 percent by volume of the raw product collapses.

Preparation of Frit

### Frit GFC-1

Frit was prepared by combining the following components: SiO₂ (600.0 g), Na₂O.2B₂O₃ (130.8 g), CaCO₃ (180.0 g), Na₂CO₃ (18.7 g), Na₂SO₄ (20.0 g), Na₄P₂O₇ (6.5 g) and Li₂CO₃ (10.7 g). Mixing was carried out by tumbling for 3 minutes in an 8.7-liter jar mill with 6000 grams of alumina grinding cylinders (both available from VWR Scientific, West Chester, Pa). The batches were melted for 3 hours in fused silica refractory crucible (N size; available from DFC Ceramics, Canon City, Colo.) at a temperature of about 1290° C. (2350° F.) in a quick recovery electrically heated furnace (available from Harper Electric, Terryville, Conn.). The resulting molten glass was quenched in water and dried resulting in Frit GFC-1.

### Frits GFC-2 through GFC-10 and GF-1 through GF-4

Frits GFC-2 to GFC-10 and GF-1 through GF-4 were prepared according to the procedure described for frit GFC-1, except that the glass composition was varied as reported in Table 1 (below).

TABLE 1

| | Amount of Component, grams | | | | | | |
|---|---|---|---|---|---|---|---|
| Frit | SiO₂ | Na₂O.2B₂O₃ | Na₂CO₃ | CaCO₃ | Na₂SO₄ | Na₄P₂O₇ | Li₂CO₃ |
| GFC-2 | 600.0 | 130.8 | 18.7 | 180.0 | 20.0 | 6.5 | 10.7 |
| GFC-3 | 600.0 | 130.8 | 18.7 | 180.0 | 20.0 | 6.5 | 10.7 |
| GFC-4 | 600.0 | 123.9 | 58.5 | 172.9 | 5.0 | 0 | 0 |
| GFC-5 | 600.0 | 123.9 | 58.5 | 172.9 | 5.0 | 0 | 0 |
| GFC-6 | 600.0 | 123.9 | 58.5 | 172.9 | 5.0 | 0 | 0 |
| GFC-7 | 600.0 | 130.8 | 18.7 | 180.0 | 20.0 | 6.5 | 10.7 |
| GFC-8 | 600.0 | 130.8 | 18.7 | 180.0 | 20.0 | 6.5 | 10.7 |
| GFC-9 | 600.0 | 123.9 | 58.5 | 172.9 | 5.0 | 0 | 0 |
| GFC-10 | 600.0 | 123.9 | 58.5 | 172.9 | 5.0 | 0 | 0 |
| GF-1 | 600.0 | 130.8 | 18.7 | 180.0 | 20.0 | 6.5 | 10.7 |
| GF-2 | 600.0 | 123.9 | 58.5 | 172.9 | 5.0 | 0 | 0 |
| GF-3 | 600.0 | 130.8 | 18.7 | 180.0 | 20.0 | 6.5 | 10.7 |
| GF-4 | 600.0 | 123.9 | 59.6 | 172.9 | 3.5 | 0 | 0 |

Preparation of Feed

### Feed FSC-1

Frit GFC-1, prepared above, was partially crushed using a disc mill (available under the trade designation “PULVERIZING DISC MILL” from Bico, Inc., Burbank, Calif.) equipped with ceramic discs and having a 0.030-inch (0.762-mm) outer gap. The resultant milled frit (approx 700 g increments) was then further milled in a fluid bed jet mill (available under the trade designation “ALPINE MODEL 100 APG” from Hosokawa Micron Powder Systems, Summit, N.J.), yielding Feed FSC-1, median size=22.58 micrometers, span=1.13.

### Feeds FSC-3, FSC-4, FSC-6, FSC-7, and FSC-9

The procedure for making feedstock FSC-1 was followed except using frits GFC-3, GFC-4, GFC-6, GFC-7, and GFC-9 in place of GFC-1 resulting in feedstocks FSC-3, FSC-4, FSC-6, FSC-7, and FSC-9, respectively, with median size and span values as reported in Table 2.

### Feeds FSC-2, FSC-5, FSC-8 and FS-1 through FS-4

The procedure of feed FSC-1 was followed using to generate feeds FSC-2, FSC-5, FSC-8 and FS-1 through FS-4 from frits GFC-2, GFC-5, GFC-8 and GF-1 through GF-4, respectively, except that after milling, each milled frit was classified into two portions using a centrifugal air classifier (available under the trade designation “ALPINE CLASSIFIER MODEL 100 MZR” from Hosokawa Micron Powder Systems). Typically, a coarse fraction and a fine fraction were isolated. Feeds FS-1 through FS-6 correspond to the coarse fraction and Feedstocks FSC-2, FSC-5, and FSC-8 correspond to the fine fraction. After classification, FS-4 was screened through a 230 mesh (U.S. mesh size) sieve.

Preparation of Glass Microbubbles

### Glass Microbubbles RPC-1

Feed FSC-1, prepared above, was passed through a natural gas/air flame of approximately stoichiometric proportions with a combustion air flow calculated to be about 25.7 liters/minute at standard temperature and pressure and an output rate of approximately 2.75 pounds/hr (1.25 kg/hr). The air:gas ratio was adjusted to yield the lowest total product density. The flame-formed product was cooled by mixing with ambient temperature air and then separated from the resulting gas stream with a cyclone device. The resulting glass microbubbles (glass microbubbles RPC-1) had a median size of 74.8 with a span of 1.72.

### Glass Microbubbles RPC-2 through RPC-9 and RP-1 through RP-4

Glass microbubbles RPC-2 to RPC-9 and RP-1 through RP-4 were prepared according to the procedure used for preparing glass microbubbles RPC-1 (above) except using Feedstocks FSC-2 through FSC-9 and FS-1 through FS-4, respectively, instead of Feed FSC-1, and using the values of gas flow and output rate reported in Table 2 (below). Further, in preparing RP-4, the flame temperature was increased by enrichment with oxygen.

TABLE 2

| | | | | | | | | Raw Product | | | |
|---|---|---|---|---|---|---|---|---|---|---|---|
| | Feed Particle | | | | Output | Raw | | Particle Size | | | |
| | Size Distribution | | | | rate, | Product | Raw Product | Distribution | | | |
| | Median size, | | Raw | Gas flow, | lbs/hr; | Density | Standard | Median size, | | Strength, | |
| Feed | micrometers | Span | Product | liters/min | (kg/hr) | (g/mL) | Deviation | micrometers | Span | psi (MPa) | |
| FSC-1 | 22.58 | 1.72 | RPC-1 | 25.7 | 2.75 (1.25) | 0.125 | 26.10 | 74.79 | 0.93 | 190 | (1.31) |
| FSC-2 | 12.35 | 1.96 | RPC-2 | 25.7 | 2.68 (1.21) | 0.157 | 17.54 | 51.61 | 0.91 | 233 | (1.61) |
| FSC-3 | 35.43 | 1.81 | RPC-3 | 25.7 | 2.60 (1.18) | 0.161 | 35.2 | 95.30 | 1.01 | 124 | (0.86) |
| FSC-4 | 25.51 | 1.66 | RPC-4 | 27.6 | 2.80 (1.27) | 0.501 | 16.85 | 42.86 | 1.09 | 11,500 | (79.3) |
| FSC-5 | 14.92 | 1.85 | RPC-5 | 27.6 | 2.80 (1.27) | 0.557 | 12.21 | 28.17 | 1.12 | 16,638 | (114.7) |
| FSC-6 | 38.18 | 1.75 | RPC-6 | 27.6 | 2.72 (1.23) | 0.594 | 23.77 | 57.05 | 1.15 | 9,653 | (66.6) |
| FSC-7 | 10.06 | 1.45 | RPC-7 | 25.7 | 2.70 (1.22) | 0.205 | 14.70 | 33.85 | 1.07 | 300 | (2.07) |
| FSC-8 | 7.19 | 1.52 | RPC-8 | 25.7 | 2.70 (1.22) | 0.245 | 15.93 | 24.20 | 1.56 | 339 | (2.34) |
| FSC-9 | 10.64 | 1.43 | RPC-9 | 27.6 | 2.70 (1.22) | 0.620 | 10.90 | 17.84 | 1.20 | 22,377 | (154.28) |
| FS-1 | 36.75 | 0.87 | RP-1 | 25.7 | 2.77 (1.26) | 0.099 | 21.20 | 88.18 | 0.62 | 170 | (1.17) |
| FS-2 | 38.46 | 0.86 | RP-2 | 27.6 | 2.80 (1.27) | 0.412 | 12.21 | 54.30 | 0.58 | 9300 | (64.12) |
| FS-3 | 14.85 | 0.77 | RP-3 | 25.7 | 2.75 (1.25) | 0.158 | 9.00 | 34.93 | 0.60 | 300 | (2.07) |
| FS-4 | 74.61 | 0.72 | RP-4 | 27.6 | 1.0 (0.45) | 0.399 | 23.09 | 109.2 | 0.56 | 4436 | (30.59) |

Various modifications and alterations of this invention may be made by those skilled in the art without departing from the scope and spirit of this invention, and it should be understood that this invention is not to be unduly limited to the illustrative embodiments set forth herein.

What is claimed is:

1. A method of forming glass microbubbles comprising heating feed under conditions sufficient to convert at least a portion of the feed into raw product comprising glass microbubbles, wherein the feed has a size distribution with a span of less than 0.9.

2. A method according to claim 1, wherein the feed is provided by a method comprising:
milling frit to provide milled frit; and
classifying the milled frit.

3. A method according to claim 2, wherein classifying comprises air classifying.

4. A method according to claim 1, wherein the span is less than 0.85.

5. A method according to claim 1, wherein the span is less than 0.80.

6. A method according to claim 1, wherein the span is less than 0.75.

7. A method according to claim 1, wherein the span is in a range of from at least 0.7 up to, but not including, 0.9.

8. A method according to claim 1, wherein the feed has a silica content in a range of from 65 to 75 percent by weight.

9. A method according to claim 1, wherein the feed has sulfur content in a range of from 0.01 to 0.65 percent by weight.

10. A method according to claim 1, wherein the raw product has a mean particle size in a range of from 5 to 250 micrometers.

11. A method according to claim 1, wherein the raw product has a mean particle size in a range of from 30 to 110 micrometers.

12. A method according to claim 1, further comprising isolating glass microbubbles from the raw product.

13. A method according to claim 1, wherein the raw product has a mean particle size of at least 70 micrometers.

14. A raw product comprising glass microbubbles, wherein on a weight basis a majority of the raw product comprises glass microbubbles, and wherein the plurality of raw product has a size distribution with a span of less than 0.80.

15. A raw product according to claim 14, wherein the span is less than 0.75.

16. A raw product according to claim 14, wherein the span is less than 0.70.

17. A raw product according to claim 14, wherein the span is less than 0.65.

18. A raw product according to claim 14, wherein the span is less than 0.60.

19. A raw product according to claim 14, wherein the glass microbubbles have a weight ratio of alkaline earth metal oxide to alkali metal oxide weight ratio in a range of 1.2:1 to 3.0:1, and wherein at least 97 percent by weight of the combined weight of the alkaline earth metal oxide and alkali metal oxide comprises, on a weight basis, of from 70 to 80 percent SiO₂, from 8 to 15 percent CaO, from 3 to 8 percent Na₂O, and from 2 to 6 percent B₂O₃.

20. A raw product according to claim 14, wherein the raw product has a distribution with a mean particle size in a range of from 5 to 250 micrometers.

21. A raw product to claim 14, wherein the raw product has a distribution with a mean particle size of at least 70 micrometers.

22. A raw product according to claim 14, wherein the raw product is dispersed in a polymeric material.

23. A raw product according to claim 22, wherein the polymeric material comprises a thermoplastic polymeric material.
